(19) United States
(12) Patent Application Publication
(10) Pub. No.: US 2016/0152331 A1
(43) Pub. Date: Jun. 2, 2016

(54) ROTOR OF AN AIRCRAFT COMPRISING A HELICAL ACTUATOR

(71) Applicant: AIRBUS DEFENCE AND SPACE GMBH, Ottobrunn (DE)

(72) Inventor: Horst Haslach, Geretsried (DE)

(73) Assignee: Airbus Defence and Space GmbH, Ottobrunn (DE)

(21) Appl. No.: 14/902,969

(22) PCT Filed: Jul. 7, 2014
(86) PCT No.: PCT/DE2014/000338

§ 371 Date: Jan. 5, 2016

(30) Foreign Application Priority Data
Jul. 5, 2013 (DE) 10 2013 011 259.1

(51) Int. Cl. B64C 27/72

(52) U.S. Cl. CPC B64C 27/72

(57) ABSTRACT

A helical actuator includes a plurality of piezo elements for controlling a rotor blade of an aircraft. In this case, the actuator is designed to be arranged so as to be wound around a rotor blade neck and to be fastened to a rotor mast and a rotor blade in each case. Applying a control voltage to the piezo elements causes the actuator to expand, which, in turn, causes the rotor blade to rotate.

### FIELD OF INVENTION The present invention relates to a rotor for an aircraft and to a helicopter.

### BACKGROUND OF THE INVENTION

Rotor blades of a helicopter can be rigidly fastened to a rotor mast by means of a resilient blade neck. The resilient blade neck can permit defined movements in an impact, pivot or rotational direction. Conventionally, a sleeve is attached over the resilient blade neck, the outside of which sleeve is firmly connected to the profile of the blade. A control rod is also arranged inside said sleeve, close to the rotor mast, the movements of which control rod causes the sleeve to rotate and the profile of the blade to change. The control movements of the control rod can be produced by a compound gear and a swashplate.

The German patent document DE 197 45 330 C1 relates to a rotor blade connection comprising a support arm which connects the rotor blade to the rotor hub, wherein the support arm has an open convex cross section and comprises piezoelectric solid elements fastened to the support arm.

DE 10 2008 036 760 A1 relates to a rotary actuator comprising at least one strip-shaped passive support layer which can be bent in a reversible manner The support layer comprises, in the support layer longitudinal direction, an active actuator coating that is applied to the support layer and can expand and/or contract in the support layer longitudinal direction upon activation.

US 2004/0017129 A1 relates to electroactive devices comprising an electroactive structure which extends along a minor axis and is curved around a main axis. This electroactive structure comprises electroactive parts which extend around the minor axis.

DE 10 2010 042 223 A1 describes a torque-generating device which comprises a torque-generating element that is substantially spirally and/or helically arranged about an axis of rotation of the torque to be generated and that comprises at least one piezo element for generating the torque.

### BRIEF SUMMARY OF THE INVENTION

The invention relates to a helical actuator for controlling a rotor blade of an aircraft. The actuator comprises a plurality of piezo elements arranged in series in order to adjust the rotor blade when a control voltage is applied to the piezo elements.

The helical actuator is an actuator in the shape of a helix. A helix can be described as a curve that winds around the lateral surface of a cylinder at a constant pitch.

The aircraft may be a helicopter, an aeroplane or an airship.

Propellers of aircraft can also be controlled by means of the helical actuator.

Piezo elements are understood to mean components that perform a mechanical movement, particularly an expansion or a contraction, when an electrical voltage is applied. These piezoelectric elements are for example piezo crystals or piezoelectric ceramics.

A serial arrangement of piezo elements means for example a stacked arrangement of the piezo elements, in which the piezo elements are arranged in series one on top of the other. In other words, a “serial arrangement” means a layered arrangement of piezo elements. Electrodes are for example arranged between the individual piezo elements. This means that an electrode is arranged between two adjacent piezo elements in each case. In order to actuate the actuator, a voltage is applied between two adjacent electrodes in each case.

For example, the actuator comprises a cascading of piezo elements in that a plurality of thin piezo elements having electrodes arranged therebetween are joined together. This results in a mechanical series arrangement actuated by an electric parallel connection. To achieve this, the following pattern can be applied: Firstly, an electrode (e.g. a cathode), a piezo element, then another electrode (e.g. an anode), and finally another piezo element having a modified direction of polarisation are arranged one on top of the other in an alternating manner. This arrangement can be repeated a number of times.

An advantage of a serial, stacked or layered arrangement is that the mechanical expansions of the individual piezo elements are added together. This means that the overall expansion of the actuator can be approximately equal to the expansion of an individual piezo element multiplied by the number of piezo elements. Therefore, an expansion of the actuator can be produced which is great enough to cause the rotor blade to be adjusted.

One advantage of a helical actuator for controlling a rotor blade of an aircraft can be considered to be that a large part of the mechanical control installation, for example the compound gear or the swashplate, is not required. Furthermore, an actuator consisting of piezo elements can be operated very quietly, and therefore the noise generated by the rotating rotor blade can be minimised. Moreover, owing to the helical actuator consisting of piezo elements, it is possible to control a rotor blade in a highly dynamic manner Actuating the rotor blades by means of an electrically operated actuator consisting of piezo elements involves few components and can be achieved in an economical manner.

According to one embodiment of the invention, each of the piezo elements has an expansion direction which is parallel to a helical direction of the actuator.

The expansion direction corresponds for example to the direction in which the piezo elements expand when a control voltage is applied. This means that the piezo elements of the actuator expand in the helical direction when the control voltage is applied. By way of example, the expansion direction of the piezo elements is a thickness direction.

This means that the thickness direction of the piezo elements is parallel to the helical direction.

In this case, the helical direction is the direction of the helical actuator, i.e. the direction of the helix in which the actuator is arranged. In other words, the helical direction at each point on the helix is a direction which is tangential to the helix.

Since the expansion direction of the piezo elements can be substantially parallel to the helical direction, the helical actuator as a whole also expands in the helical direction. A movement of the rotor blade substantially in the helical direction can be produced by means of the actuator. This means that a rotor blade to which a helical actuator is connected can rotate about a central axis of the actuator, about which the actuator winds.

According to another embodiment of the invention, the actuator winds around a volume of space along a central axis of the actuator.

In this case, the central axis is an axis in the longitudinal direction of the helical actuator. In other words, the helical actuator winds around its central axis.

A resilient rotor blade neck of a rotor can for example be located in this volume of space. This means that a further element, e.g. a rotor blade neck, can be located in the volume of space of the helical actuator.

According to another embodiment of the invention, the actuator comprises at least 100 piezo elements.

By way of example, the actuator comprises piezo elements which each have a thickness of between 0.2 mm and 1.0 mm in the helical direction. In other words, the actuator contains stacked small plates or discs consisting of piezo elements which are arranged perpendicularly to the helical direction, i.e. the plane which defines each of the small plates is arranged perpendicularly to the helical direction. In each case, the piezo elements expand in the thickness direction of said piezo elements.

According to another embodiment of the invention, the piezo elements are surrounded by a fibre composite material. This could for example be a matrix made of a fibre composite fabric.

In this case, the fibre composite material surrounding the piezo elements defines the helix shape of the actuator. Furthermore, the fibre composite material is flexible, and therefore the piezo elements can expand and the actuator as a whole can also expand. Moreover, wires or other electric conductors can be built into the fibre composite material in order to apply the control voltage to the piezo elements.

According to another embodiment of the invention, the actuator comprises at least three turns.

According to another embodiment of the invention, applying a control voltage to the piezo elements causes the actuator to expand in a helical direction of the actuator.

The invention also relates to a rotor for an aircraft, comprising at least one rotor blade. The rotor further comprises a rotor blade connection which is designed to connect the rotor blade to the rotor mast. The rotor further comprises a resilient blade neck which connects the rotor blade to the rotor blade connection and allows the rotor blade to rotate about an axis of rotation in the longitudinal direction of the rotor blade. The rotor also comprises a helical actuator as described above and below which is arranged so as to wind around the rotor blade neck.

In general, the rotor may also be a propeller.

By way of example, the rotor comprises a rotor mast and four rotor blades which are each connected to the rotor mast.

The rotor blade connection may be a component to which the rotor blade is connected by means of the rotor blade neck. Alternatively, the rotor blade connection can also be an end of a rotor blade which connects the rotor blade to the rotor mast or at which the rotor blade can be connected to the rotor mast. The rotor blade connection is connected to the rotor mast by screws or bolts for example. On the other hand, the rotor blade neck can be a component which is arranged between the rotor blade connection and the rotor blade, and therefore the rotor blade neck connects the rotor blade to the rotor blade connection. The rotor blade, rotor blade neck and rotor blade connection can also be different regions of a one-piece component.

In the process, the rotor blade neck permits a movement in the rotational direction about an axis of rotation of the rotor blade. The axis of rotation of the rotor blade is an axis of the rotor blade which extends in the longitudinal direction of the rotor blade. In other words, the rotor blade expands to the greatest degree in the direction of the axis of rotation. For example, the axis of rotation of the rotor blade can be substantially perpendicular to a rotation axis of the rotor mast. A rotational movement of the rotor blade can also be a rotary movement of the rotor blade about the axis of rotation of the rotor blade.

Such a rotational movement of the rotor blade about the axis of rotation of the rotor blade can be produced by means of the helical actuator. The lift and/or forwards thrust of the rotor can thus be controlled by means of this actuator.

According to the invention, the helical actuator is fastened by a first end to the rotor mast and by a second end to the rotor blade.

In other words, the actuator is firmly connected to the rotor mast and the rotor blade, and therefore a force from the actuator is transmitted to the rotor mast and/or the rotor blade. For example, owing to this connection, the actuator pushes away from the rotor mast and transfers its expansion to the rotor blade, thus producing a rotational movement of the rotor blade.

According to another embodiment of the invention, the helical actuator is fastened to the rotor blade at a distance from the axis of rotation of the rotor blade, which axis extends in the longitudinal direction of the rotor.

Owing to this distance between the fastening of the actuator to the rotor blade and the axis of rotation of the rotor blade, the actuator has a lever for rotating the rotor blade about the axis thereof. This lever corresponds to the distance between the point where the actuator is fastened to the rotor blade and the axis of rotation of the rotor blade.

According to another embodiment of the invention, the helical actuator circulates around the blade neck at least three times.

According to another embodiment of the invention, the rotor blade is made to rotate when a control voltage is applied to the helical actuator.

The invention also relates to a helicopter comprising at least one rotor as described above and below.

For example, it relates to an electrically driven helicopter which comprises electric motors for driving one or more rotors. The helicopter may also be a fuel-operated helicopter, the rotor blades of which are actuated by means of helical actuators. The helicopter may also be a model helicopter or a drone.

Further features, advantages and possible uses of the invention can be found in the following description of the embodiments and figures. Here, all the described and/or illustrated features form, per se and in any combination, the subject matter of the invention, regardless of how they are combined in the individual claims or their dependency references.

### BRIEF DESCRIPTION OF THE DRAWINGS

FIG. 1 shows a helical actuator according to an embodiment of the invention.

FIG. 2 shows a rotor having a helical actuator according to an embodiment of the invention.

FIG. 3 shows a helicopter according to an embodiment of the invention.

The figures are schematic and are not true to scale. If, in the following description, the same reference numerals are used in different figures, said reference numerals identify identical or similar elements. However, identical or similar elements can also be identified by different reference numerals.

### DETAILED DESCRIPTION

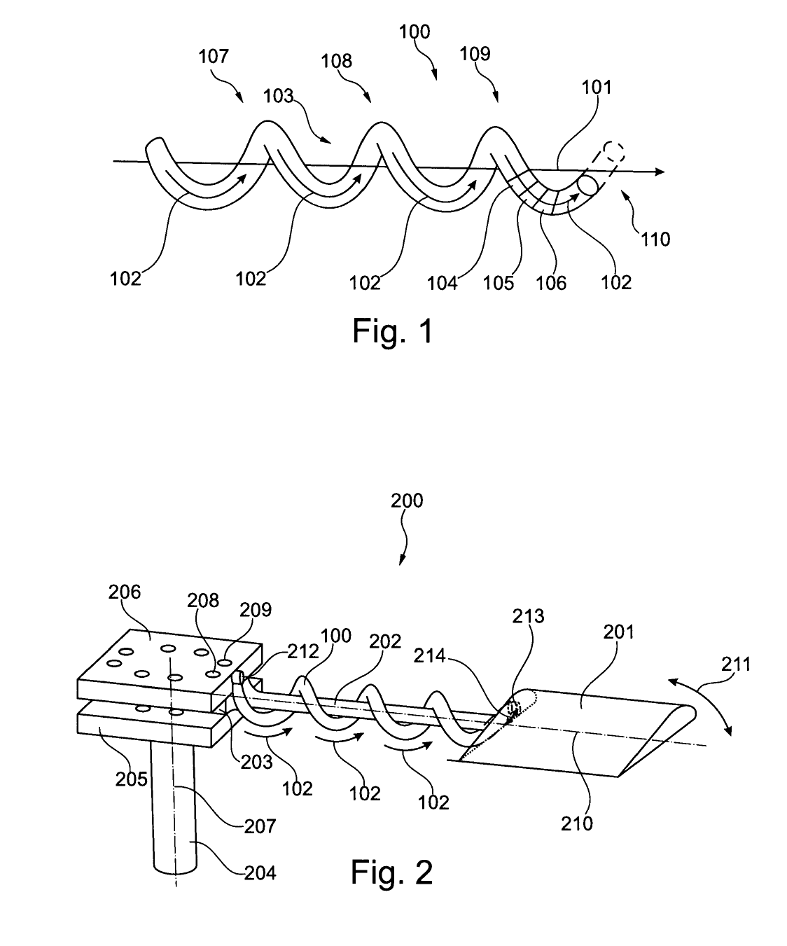

FIG. 1 shows a helical actuator 100 according to an embodiment of the invention. The helical actuator 100 is shaped like a helix which is arranged about a central axis 101. At the same time, the central axis 101 also defines the longitudinal direction 101 of the helical actuator 100. Furthermore, the helical actuator defines a helical direction 102 which points in the direction of the helix, in which direction the actuator 100 is arranged. Moreover, a volume of space 103 is located inside the actuator 100 along the central axis 101 of the actuator, around which volume of space the actuator 100 winds.

The helical actuator comprises a plurality of piezo elements arranged in series, i.e. one on top of the other. By way of example, three piezo elements 104, 105, 106 arranged one on top of the other are shown.

In the present embodiment, the helical actuator has three complete turns 107, 108, 109 and one half turn adjacent to the turn 109.

Applying a control voltage to the piezo elements 104, 105 and 106 causes the individual piezo elements 104, 105, 106 to expand in the helical direction 102. As a whole, this results in an expansion 110 of the actuator 100 in the helical direction 102, which expansion is for example equal to the expansion of an individual piezo element multiplied by the number of piezo elements. In FIG. 1, the expansion 110 of the actuator is shown by a dashed line.

When the control voltage is applied to the actuator 100, the actuator expands such that the shape thereof includes the solid line and the expansion 110 represented by the dashed line. If no control voltage is applied, the actuator 100 has the shape as shown by the solid line.

FIG. 2 shows a rotor 200 according to an embodiment of the invention. The rotor may comprise a rotor mast 204 to which a rotor blade 201 is connected. In this case, a rotor blade neck 202 connects the rotor blade 201 to a rotor blade connection 203 which is connected to the rotor mast 204. In the present embodiment, the rotor blade connection is an end of the rotor blade neck 202 and is clamped between a lower fastening plate 205 and an upper fastening plate 206. Furthermore, the rotor blade connection 203 is connected to the lower fastening plate 205 and the upper fastening plate 206 by bolts 208 and 209.

In addition to the rotor blade 201, three further rotor blades (not shown) can be attached to the rotor mast 204.

A helical actuator 100 is arranged around the rotor blade neck 202 and winds around the rotor mast 204. Furthermore, the actuator 100 is fastened to the rotor mast 204. In the present embodiment, the actuator is fastened to the upper fastening plate 206 by means of a fastening element 212. The actuator 100 is also fastened to the rotor blade 201 by means of a fastening element 213. The rotor blade has an axis of rotation 210 which extends in the longitudinal direction of the rotor blade. The helical actuator 100 is arranged at a distance 214 from this axis of rotation 210 of the rotor blade 201, and therefore the helical actuator applies a leverage force to the rotor blade 201 relative to the axis of rotation 210.

FIG. 2 shows different axes and directions. The rotor mast comprises a rotation axis 207, about which the rotor mast rotates. The rotor blade also comprises an axis of rotation 210 as described above which extends in the longitudinal direction of the rotor blade. The rotation axis of the rotor mast 207 and the axis of rotation 210 of the rotor blade 201 are arranged substantially perpendicularly to one another. The helical direction 102 of the actuator is also shown which extends along a helix along which the actuator is arranged. A rotational direction 211 which the rotor blade 201 can follow is also shown. The rotational direction or rotational movement 211 corresponds substantially to a rotational movement and/or rotary movement about the axis of rotation 210 of the rotor blade 201. A rotational movement 211 of the rotor blade 201 is produced by the control voltage being applied to the piezo elements 104, 105 and 106 of the actuator 100.

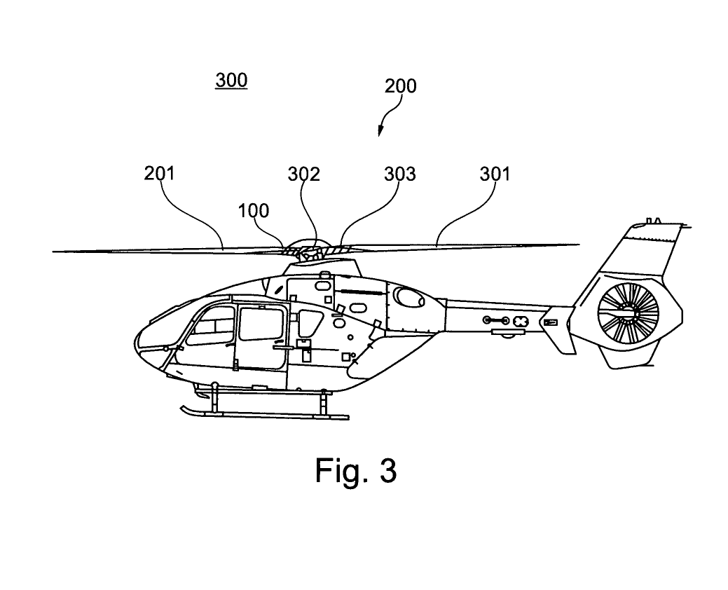

FIG. 3 shows a helicopter according to an embodiment of the invention. The helicopter 300 comprises a rotor 200 which, in this case, is a main rotor. The rotor 200 comprises for example four rotor blades, the three rotor blades 201, 301 and 302 being visible in the present embodiment. The rotor blade 201 can be controlled by means of a helical actuator 100, and the rotor blade 301 can be controlled by means of a helical actuator 303. The additional rotor blades can also be controlled by means of helical actuators.

For completeness, it should be noted that “comprising” or “having” does not preclude other elements and “a” or “one” does not preclude a plurality. It should further be noted that features which have been described with reference to one of the above embodiments may also be used in combination with other features of other embodiments which are disclosed above. Reference numerals in the claims should not be considered to be limiting.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A rotor for an aircraft, the rotor comprising:
a rotor blade;
a rotor blade connection configured to connect the rotor blade to a rotor mast;
a resilient blade neck connecting the rotor blade to the rotor blade connection and permitting a rotational movement of the rotor blade about an axis of rotation in the longitudinal direction of the rotor blade; and
a helical actuator for controlling the rotor blade of the aircraft;
wherein the helical actuator is arranged so as to be wound around the resilient blade neck,
wherein the helical actuator is fastened by a first end to the rotor mast and by a second end to the rotor blade, and
wherein the actuator comprises a plurality of piezo elements arranged in series to adjust the rotor blade when a control voltage is applied to the piezo elements.

2. The rotor according to claim 1, wherein each of the piezo elements has an expansion direction parallel to a helical direction of the actuator.

3. The rotor according to claim 1, wherein the actuator winds around a volume of space along a central axis of the actuator.

4. The rotor according to claim 1, wherein the actuator comprises at least 100 piezo elements.

5. The rotor according to claim 1, wherein the piezo elements are surrounded by a fibre composite material.

6. The rotor according to claim 1, wherein the actuator has at least three turns.

7. The rotor according to claim 1, wherein an expansion of the actuator is produced in a helical direction of the actuator when a control voltage is applied to the piezo elements.

8. The rotor according to claim 1, wherein the helical actuator is fastened to the rotor blade at a distance from the axis of rotation of the rotor blade, the axis extending in the longitudinal direction of the rotor blade.

9. The rotor according to claim 1, wherein the helical actuator circulates the blade neck at least three times.

10. The rotor according to claim 1, wherein a rotational movement of the rotor blade is produced when a control voltage is applied to the helical actuator.

11. A helicopter comprising at least one rotor, the rotor comprising:
a rotor blade;
a rotor blade connection configured to connect the rotor blade to a rotor mast;
a resilient blade neck connecting the rotor blade to the rotor blade connection and permitting a rotational movement of the rotor blade about an axis of rotation in the longitudinal direction of the rotor blade; and
a helical actuator for controlling the rotor blade of the aircraft;
wherein the helical actuator is arranged so as to be wound around the resilient blade neck,
wherein the helical actuator is fastened by a first end to the rotor mast and by a second end to the rotor blade, and
wherein the actuator comprises a plurality of piezo elements arranged in series to adjust the rotor blade when a control voltage is applied to the piezo elements.
